(19) United States
(12) Patent Application Publication
(10) Pub. No.: US 2018/0147122 A1
(43) Pub. Date: May 31, 2018

(54) A CONTAINER GRIPPING AID

(71) Applicant: Ollwyn Agnes Moran, Dublin (IE)

(72) Inventor: Ollwyn Agnes Moran, Dublin (IE)

(21) Appl. No.: 15/573,698

(22) PCT Filed: May 11, 2016
(86) PCT No.: PCT/EP2016/060576

§ 371 Date: Nov. 13, 2017

(30) Foreign Application Priority Data
May 11, 2015 (IE) S2015/0144

(51) Int. Cl. A61J 9/06

(52) U.S. Cl. CPC A61J 9/0623

(57) ABSTRACT

A container gripping aid (1) has a jacket (2) for reception of a container such as a baby bottle (3). The jacket (2) has a mesh configuration with a plurality of through-holes (5) to facilitate gripping of the jacket (2) by a baby. The jacket (2) has an egg-like shape. Thus, when it is engaged with the bottle (3), most of the jacket (2) side wall is supported spaced-apart from an exterior side wall (6) of the container (3) which enables a baby to easily grip the mesh of the jacket (2).

### INTRODUCTION

This invention relates to a container gripping aid and in particular to a device for mounting on a baby bottle to facilitate gripping and holding of the baby bottle by a baby for feeding.

Various holding devices for baby bottles have previously been proposed and examples are to be found in U.S. Pat. No. 8,998,029, U.S. Pat. No. 8,152,012, U.S. Pat. No. 5,513,885, U.S. Pat. No. 4,941,579 and U.S. Pat. No. 3,058,708. These documents all essentially show devices which engage with the baby bottle and provide outwardly projecting handles which, for a baby, are more easily gripped than the bottle itself. While these devices do provide improved grip for the baby, they are not entirely satisfactory.

The present invention is directed towards providing an improved container gripping aid, in particular for a baby bottle.

### SUMMARY OF THE INVENTION

According to the invention there is provided a container gripping aid, including:
a jacket for reception, of the container;
retaining means for securing the jacket in engagement with the container; and
the jacket having means for gripping the jacket to support the container.

In one embodiment of the invention, the jacket has a plurality of perforations or holes to provide the gripping means.

In another embodiment, the jacket has a mesh configuration. Thus, advantageously, the jacket can be readily easily gripped at any location.

In another embodiment, the mesh configuration is formed by a plurality of substantially circular holes in the jacket.

In another embodiment, the jacket is resiliently deformable.

In another embodiment, the jacket is formed by a stiff, but flexible material. That is the jacket is stiff enough to naturally hold its shape, but will at the same time easily deform when handled or gripped. In this regard, thermoplastic elastomers are particularly suitable for forming the jacket.

In another embodiment, the jacket has a somewhat bulbous or egg-like shape. Thus, when it is engaged with the container, a central portion of the jacket, intermediate the top and bottom of the jacket, is supported spaced-apart from an exterior of the container. This conveniently facilitates the user in gripping the jacket.

In a further embodiment, the jacket is sufficiently see-through to allow a container within the jacket to be viewed when the jacket is mounted on the container.

In another embodiment, the retaining means includes a clamp at a top of the jacket.

In another embodiment, the clamp comprises a pair of resiliently deformable opposed clamp arms.

In another embodiment, the clamp arms curve inwardly at a top of the jacket.

In another embodiment, the retaining means further includes an inwardly extending base support at a bottom of the jacket.

In another embodiment, the base support comprises an opposed pair of support arms which project inwardly at the bottom of the jacket.

In another embodiment, each support arm extends inwardly and upwardly at the bottom of the jacket.

In another embodiment, each base support arm is resiliently deformable.

In another embodiment, the jacket is adapted for mounting on a baby bottle.

In a further embodiment, the clamp arms are engagable with a shoulder at a top of the baby bottle and the base support arms are engagable with a base of the baby bottle extending in under the base of the baby bottle. Thus, essentially the whole bottle is substantially encased in the jacket.

In another embodiment complementary interengagable formations are provided on the jacket and on an associated container for releasable interengagement of the jacket and the container.

In another embodiment a bottom of the jacket is shaped for reception of the bottom of the container.

In another embodiment a rib or groove is provided on an exterior of the container or engagement with a complementary rib or groove on the jacket.

In another embodiment an inwardly directed rib is provided at an upper rim of the jacket for engagement with an associated groove on the container. Conveniently the groove is provided adjacent a rim of the container.

In another embodiment the jacket has inwardly directed spacer ribs on an inner wall of the jacket to maintain a side wall of the jacket spaced-apart from the container in use.

### BRIEF DESCRIPTION OF THE DRAWINGS

The invention will be more clearly understood by the following descriptions of some embodiments thereof, given by way of example only, with reference to the accompanying drawings, in which:

FIG. 1 is a perspective view of a container gripping aid according to the invention;

FIG. 2 is a sectional elevational view of the container gripping aid;

FIG. 3 is an elevational view of the container gripping aid;

FIG. 4 is an end elevational view of the container gripping aid;

FIG. 5 is a plan view of the container gripping aid;

FIG. 6 is an underneath plan view of the container gripping aid;

FIG. 7 is an elevational view showing the container gripping aid in use mounted on a baby bottle;

FIG. 8 is an end elevational view of the container gripping aid mounted on the baby bottle;

FIG. 9 is a sectional elevational view showing the container gripping aid mounted on the baby bottle;

FIG. 10 is a perspective view of another container gripping aid according to the invention;

FIG. 11 is an elevational view of the container gripping aid of FIG. 10;

FIG. 12 is a side elevational view of the container gripping aid of FIG. 10;

FIG. 13 is an underneath plan view of the container gripping aid of FIG. 10;

FIG. 14 is a perspective view of a cup for use with the container gripping aid of FIG. 10;

FIG. 15 is a front elevational view of the cup of FIG. 14;

FIG. 16 is a side elevational view of the cup of FIG. 14;

FIG. 17 is an underneath plan view of the cup of FIG. 14;

FIG. 18 is a sectional elevational view of the cup of FIG. 14 mounted within the container gripping aid of FIG. 10;

FIG. 19 is an elevational view of the cup and container gripping aid shown in FIG. 18; and

FIG. 20 is a perspective view of the cup and container gripping aid shown in FIG. 18.

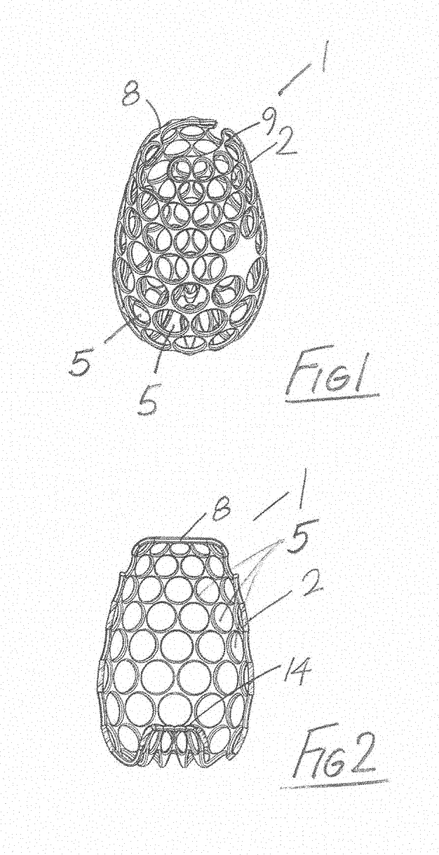

### DETAILED DESCRIPTION OF THE PREFERRED EMBODIMENTS

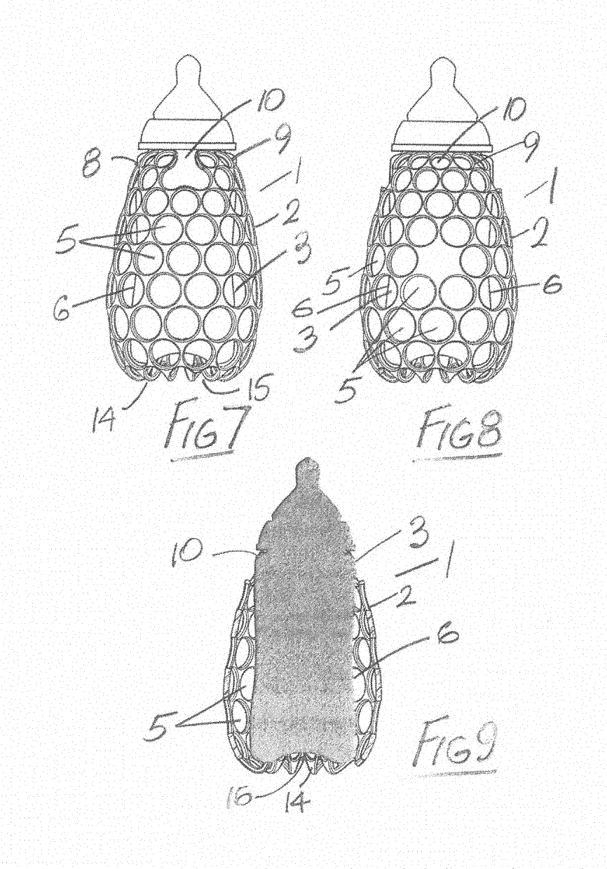

Referring to the drawings, there is illustrated a container gripping aid according to the invention indicated generally by the reference numeral 1. The container gripping aid 1 has a jacket 2 for reception of a container such as a baby bottle 3 as shown in FIGS. 7 to 9. The jacket 2 has a mesh configuration with a plurality of circular through-holes 5 to facilitate gripping of the jacket 2 by a baby.

The jacket 2 has an egg-like shape. Thus, when it is engaged with the bottle 3, most of a side wall of the jacket 2 is supported spaced-apart from an exterior side wall 6 of the container 3 as best seen in FIG. 9. This enables a baby to easily grip the mesh of the jacket 2 and thus handle and support the bottle 3.

The jacket 2 engages with a top and with a bottom of the bottle 3 to securely retain the jacket 2 on the bottle 3. A pair of resiliently deformable opposed clamp arms 8, 9 at a top of the jacket 2 move apart sufficiently to allow through-passage of the bottle 3 and then resiliently clamp against a shoulder 10 at a top of the bottle 3. It will be noted from FIG. 3 and FIG. 7 that these clamp arms 8, 9 curve inwardly at a top of the jacket 2 and snugly fit over and clamp against the shoulder 10 at the top of the bottle 3.

At a lower end of the jacket 2 an opposed pair of resiliently deformable support arms 14, 15 project inwardly and upwardly at a bottom of the jacket 2 for engagement with a base 16 of the bottle 3.

Preferably the jacket 2 is formed from a stiff but flexible material such as a thermoplastic elastomer, so it will naturally hold its shape, but will also readily easily deform to facilitate gripping the jacket 2.

It will be noted that the mesh of the jacket 2 is sufficiently open to be see-through and allow the contents of the bottle 3 to be viewed. The holes 5 or perforations in the jacket 2 forming the mesh may be of any suitable shape.

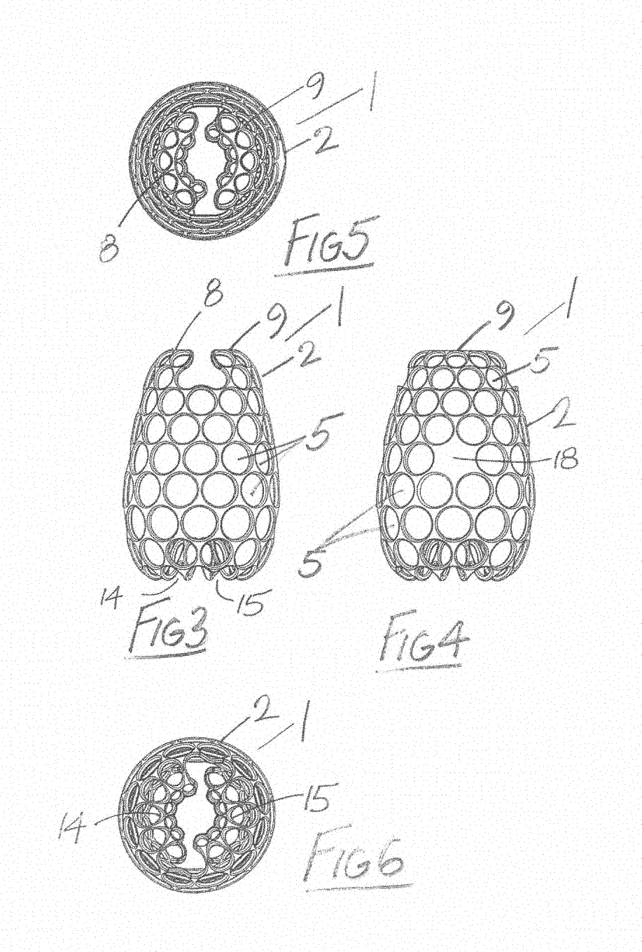

While the jacket 2 has a plurality of perforations or holes 5 substantially throughout the jacket 2, a solid panel 18 (FIG. 4) for carrying a logo or the like may be provided on the jacket 2.

In use, a baby bottle 3 can be inserted into the jacket 2 of the container gripping aid 1 as shown in FIGS. 7 to 9. The clamp arms 8, 9 at a top of the jacket 2 embrace and grip the shoulder 10 at a top of the bottle 3 and the support arms 14, 15 at a bottom of the jacket 2 project inwardly and upwardly against the base 16 of the bottle 3 to securely retain the bottle 3 within the jacket 2. It will be noted that substantially all the side wall of the jacket 2 is held spaced-apart from an exterior side wall 6 of the bottle 3 and thus a baby can readily easily grip the jacket 2 at any position from top to bottom of the bottle 3 around the whole exterior of the bottle 3.

While the embodiment of the invention previously described herein is concerned with providing a container gripping aid for a baby bottle, it is envisaged that the container gripping aid of the invention may also be used with other bottles and other containers where it is desirous to make such containers easier to grip for whoever is likely to be using the container. For example, many elderly people, or invalids have limited grip strength and thus the container gripping aid of the invention may be of benefit to them in holding various containers for drinks and the like.

It will be appreciated that the container gripping aid of the invention is easy to fit onto and remove from a bottle or other container and is also readily easily cleaned as required.

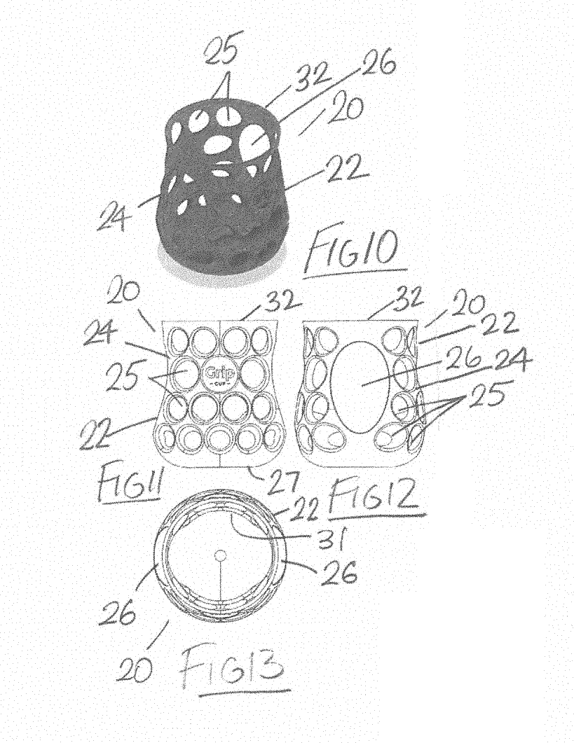

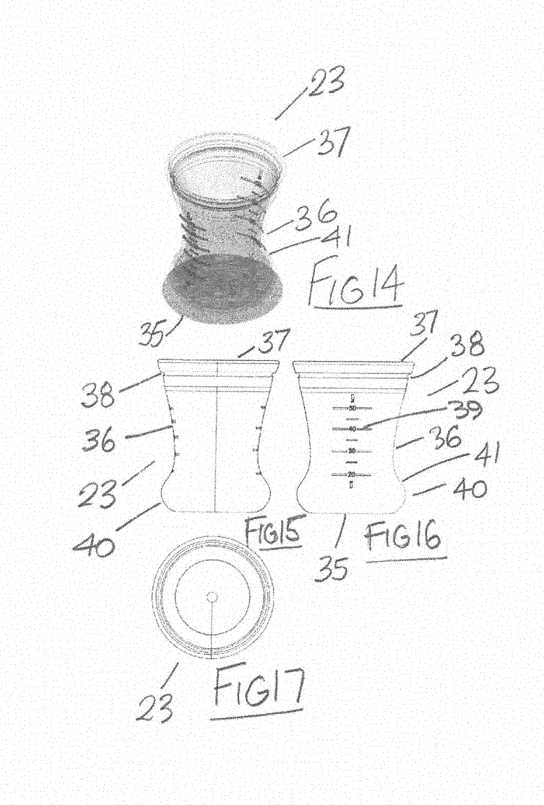

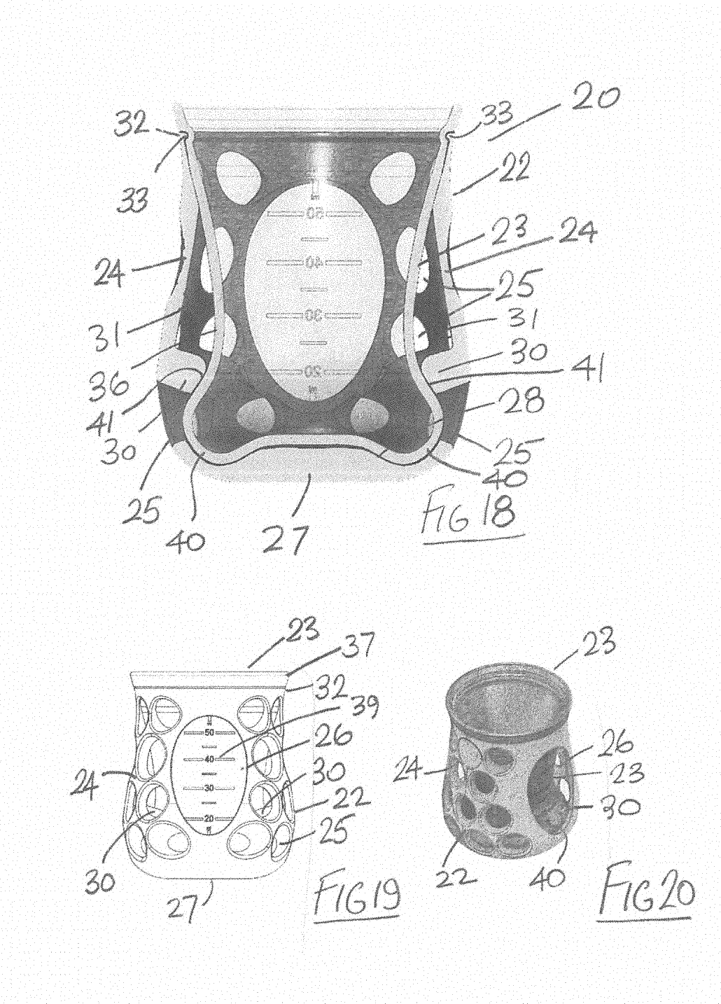

Referring now to FIGS. 10 to 20, there is shown another container gripping aid according to a second embodiment of the invention, indicated generally by the reference numeral 20. This is largely similar to the container gripping aid described previously, however in this case the gripping aid 20 comprises a jacket 22 for reception of a container comprising an associated cup 23 (FIG. 14). The jacket 22 has a mesh configuration side wall 24 with a plurality of through holes 25 to facilitate gripping the jacket 22 to support the cup 23. In addition, larger ovoid openings 26 at opposite sides of the jacket 22 facilitate viewing the cup 23 and contents thereof when the cup 23 is mounted within the jacket 22.

A bottom 27 of the jacket has an inner face 28 shaped to receive and snugly fit the cup 23. In addition, resilient spacer ribs 30 project inwardly from an inner face 31 of the side wall 24 of the jacket 22 to retain a side wall 24 of the jacket 22 spaced-apart from the cup 23, as best seen in FIG. 18. Further, a top rim 32 of the jacket 22 has an inwardly directed rib 33 for cooperation and snap engagement with the cup 23 to secure the cup 23 within the jacket 22.

Referring in particular to FIGS. 14 to 17, there is shown the cup 23 for use with the container gripping aid 20 of FIG. 10. The cup 23 has a base 35 with an upstanding, generally concave, sidewall 36 terminating in an upper rim 37. Measurement indicia 39 for measuring the contents of the cup 23 may be provided on the side wall 36 and aligned in use with the large openings 26 in the jacket 22.

Located just below the rim 37 and spaced-apart therefrom is a circumferential slot or grove 38 for reception of the rib 33 at a rim 32 of the jacket 22. It will be noted that the resilient spacer ribs 30 on the inner face 31 of the jacket 22 will deflect to allow through passage of a bulbous bottom portion 40 of the cup 23. When the cup 23 is fully inserted into the jacket 23 the ribs 30 engage an upper shoulder 41 of the bottom portion 40 to securely retain the cup 23 in the jacket 22.

FIGS. 18 to 20 show the cup 23 mounted within the container gripping aid 20 ready for use. The holes 25 in the jacket 22 allow a user to securely grip the jacket to support the cup 23.

The terms “comprise” and “include”, and any variations thereof required for grammatical reasons, are to be considered as interchangeable and accorded the widest possible interpretation. Further, selected features of the various embodiments described may be combined in any desired combination to provide the gripping aid.

The invention is not limited to the embodiments hereinbefore described which may be varied in both construction and detail within the scope of the appended claims.

1. A container gripping aid comprising:
a jacket for reception of the container, the jacket having a mesh configuration, the jacket being resiliently deformable and being formed by a stiff but flexible material;
retaining means for securing the jacket in engagement with the container such that a side wall of the jacket is supported spaced-apart from an exterior side wall of the container, the retaining means comprising a pair of resiliently deformable opposed clamp arms which extend inwardly at a top of the jacket for engagement with a top of the container and a base support comprising an opposed pair of support arms which project inwardly at a bottom of the jacket for engagement with a bottom of the container; and
the jacket having means for gripping the jacket to support the container the jacket gripping means comprising a plurality of perforations or through holes in the jacket to facilitate gripping the jacket to support the container.

2. (canceled)

3. (canceled)

4. The container gripping aid as claimed in claim 1 wherein the mesh configuration is formed by a plurality of substantially circular holes in the jacket.

5. (canceled)

6. (canceled)

7. The container gripping aid as claimed in claim 1 wherein the jacket has a somewhat bulbous or egg-like shape.

8. The container gripping aid as claimed in claim 1 wherein the jacket is sufficiently see-through to allow a container within the jacket to be viewed when the jacket is mounted on the container.

9. (canceled)

10. (canceled)

11. The container gripping aid as claimed in claim 1 wherein the clamp arms curve inwardly at a top of the jacket.

12. (canceled)

13. (canceled)

14. The container gripping aid as claimed in claim 13 wherein each support arm extends inwardly and upwardly at the bottom of the jacket.

15. The container gripping aid as claimed in claim 14 wherein each base support arm is resiliently deformable.

16. The container gripping aid as claimed in claim 1 wherein the jacket is adapted for mounting on a baby bottle.

17. The container gripping aid as claimed in claim 16 wherein the clamp arms are engagable with a shoulder at a top of the baby bottle and the base support arms are engagable with a base of the baby bottle extending in under the base of the baby bottle.

18. The container gripping aid as claimed in claim 1 wherein complementary interengagable formations are provided on the jacket and on an associated container for releasable interengagement of the jacket and the container.

19. The container gripping aid as claimed in claim 18 wherein a bottom of the jacket is shaped for reception of the bottom of the container.

20. The container gripping aid as claimed in claim 18 wherein a rib or groove is provided on an exterior of the container for engagement with a complementary rib or groove on the jacket.

21. The container gripping aid as claimed in claim 20 wherein an inwardly directed rib is provided at an upper rim of the jacket for engagement with an associated groove adjacent a rim of the container.

22. The container gripping aid as claimed in claim 18 wherein the jacket has inwardly directed spacer ribs on an inner wall of the jacket to maintain a side wall of the jacket spaced-apart from the container in use.
